(19) United States
(12) Patent Application Publication
(10) Pub. No.: US 2017/0331571 A1
(43) Pub. Date: Nov. 16, 2017

(54) FLEXIBLE MEDIA MODULES AND SYSTEMS AND METHODS OF USING SAME

(71) Applicant: Molex, LLC, Lisle, IL (US)

(72) Inventors: Jesse J. Cole, Minneapolis, MN (US); David J. King, Eagan, MN (US)

(73) Assignee: Molex, LLC, Lisle, IL (US)

(21) Appl. No.: 15/366,829

(22) Filed: Dec. 1, 2016

Related U.S. Application Data
(60) Provisional application No. 62/262,643, filed on Dec. 3, 2015.

(51) Int. Cl. H04H 20/86; G01S 19/13; H04H 40/27; G06Q 30/02; B64D 1/02

(52) U.S. Cl. CPC H04H 20/86; G01S 19/13; H04H 40/27; B64D 1/02; G06Q 30/0241

(57) ABSTRACT

A system and/or method include top and bottom substrates, and a flexible printed circuit assembly. The circuit assembly can be positioned between the top and bottom substrates. The circuit assembly can include a flexible printed circuit board, a microcontroller associated with the printed circuit board, the microcontroller having a media message programmed therein, a power-limited source of electrical energy associated with the printed circuit board, a playback device associated with the printed circuit board, the playback device being configured to play the media message, and an initiation device associated with the printed circuit board, the initiation device being configured to cause the playback device to play the media message. The printed circuit board can also include a plurality of conductive traces printed on the printed circuit board which electrically interconnect the microcontroller, the power-limited source of electrical energy, the playback device, and the initiation device.

### CROSS-REFERENCE TO RELATED APPLICATIONS

This patent application claims the benefit of U.S. Provisional Patent Application No. 62/262,643, filed on Dec. 3, 2015, the entire content of which is incorporated by reference in its entirety.

### STATEMENT OF U.S. GOVERNMENT SUPPORT

This Invention was made with Government support under Agreement No. W911NF-10-3-0001 awarded by the Army Research Laboratory (ARL). The Government has certain rights in the Invention.

### BACKGROUND

Handheld media-playing battery-powered products have existed in the global marketplace with capabilities that span playing audio, displaying video, and interacting with web pages. These extreme-performance devices have demonstrated impressive capability for achieving functional requirements in ever-shrinking packages. These products fill the need for an engaging user experience that is not tied to any stationary objects.

Over many product development cycles, it has become increasingly apparent that the minimum thickness and weights that can be attained by these extreme-performance devices are limited by the component geometries and the manufacturing techniques used for integrating these components onto printed circuit boards.

Electronic greeting cards have existed as high volume products for quite some time as well. For the case of electronic greeting cards, the recent trend has involved adding extra volume to the overall product package to accommodate electronic component thicknesses. The extra volume in the product package accommodates high-visibility buttons and other means for user interaction as well, as this reflects the need to make electronic card functionality more attractive and intuitive to users. This trend of scaling up the size of the product package reflects the rising expectations for performance in handheld devices, and the bulky, lumpy, and/or heavy electronic greeting cards that result from this trend show the limits of the present state-of-the-art in cost-effective printed circuit board (PCB) manufacturing techniques.

### SUMMARY

A powered module can include a top substrate; a bottom substrate; and a flexible printed circuit assembly, the flexible printed circuit assembly being positioned between the top substrate and the bottom substrate, the flexible printed circuit assembly including, a flexible printed circuit board, a microcontroller associated with the flexible printed circuit board, the microcontroller having a media message programmed therein, a power-limited source of electrical energy associated with the flexible printed circuit board, a playback device associated with the flexible printed circuit board, the playback device being configured to play the media message, an initiation device associated with the flexible printed circuit board, the initiation device being configured to cause the playback device to play the media message, and a plurality of conductive traces printed on the flexible printed circuit board which electrically interconnect the microcontroller, the power-limited source of electrical energy, the playback device, and the initiation device.

In one aspect, the media message is a pre-programmed media message.

In one aspect, the power-limited source is one or more thin flexible batteries.

In one aspect the power-limited source is printed on the flexible printed circuit board.

In one aspect, the power-limited source is one or more solar cells.

In one aspect, the programmed message is an audio message, and wherein the playback device is an audio playback device.

In one aspect, the audio playback device is a speaker.

In one aspect, the speaker is printed on the flexible printed circuit board.

In one aspect, the audio playback device includes separated left and right speakers to provide stereo audio.

In one aspect, the programmed message is a visual message, and wherein the playback device is a video playback device.

In one aspect, the video playback device is a video display.

In one aspect, the video display can display a static image, animated frames and/or full speed video.

In one aspect, the video display is bi-stable.

In one aspect, the flexible printed circuit assembly further includes a video controller integrated circuit to interpret video information from the microcontroller and to pass the video information to the video display.

In one aspect, the initiation device is one of a button, a switch, and a sensor.

In one aspect, the initiation device is a plurality of buttons, switches, and/or sensors.

In one aspect, the initiation device is printed on the flexible printed circuit board.

In one aspect, one or both of the top and bottom substrates have one or more openings provided therethrough in order to provide access to the playback device.

In one aspect, one or both of the top and bottom substrates have one or more openings provided therethrough in order to provide access to the initiation device.

In one aspect, one or both of the top and bottom substrates are formed of a clear or translucent material.

In one aspect, at least one of the top and bottom substrates is formed of a material which can have indicia printed thereon.

In one aspect, at least one of the top and bottom substrates is formed of a thin, lightweight and flexible material.

In one aspect, the powered module is configured to be fixed in place to a separate object.

In one aspect, the bottom substrate has an adhesive applied to a back side thereof, and a liner applied to the adhesive, wherein the liner can be removed such that the adhesive can be secured to the separate object, thereby securing the powered module to the separate object.

In one aspect, the top substrate has an adhesive applied to a back side thereof around the flexible printed circuit assembly, and wherein the bottom substrate is a liner applied to the adhesive, wherein the liner can be removed such that the adhesive can be secured to the separate object, thereby securing a remainder of the powered module to the separate object.

In one aspect, the powered module is utilized in an electronic greeting card.

In one aspect, the powered module is utilized in or as an advertising leaflet or mailer.

In one aspect, the powered module is utilized in or as an air-dropped leaflet or booklet.

In one aspect, the flexible printed circuit assembly further includes a data communication module and an associated data communication antenna, wherein the data communication module is configured to transmit and/or receive data wirelessly.

In one aspect, the data can be transmitted and/or received using a long-range, low-power communication protocol or a long-range RF data transmission protocol.

In one aspect, the long-range, low-power communication protocol is Long Range (LoRa).

In one aspect, the long-range RF data transmission protocol is one of Global System for Mobile Communications (GSM) and Time Division Multiple Access (TDMA).

In one aspect, the data communication antenna is implemented as either a discrete part or as a printed trace on the flexible printed circuit board.

In one aspect, the data communication antenna is either a passive device or an active device.

In one aspect, the powered module is provided as a part of a system, where the system further comprises at least one wireless data communication gateway, the at least one wireless data communication gateway is configured to broadcast downlink data to the data communication module, the data communication module is configured to uplink data to the at least one wireless data communication gateway.

In one aspect, the at least one wireless data communication gateway is fixed in position.

In one aspect, the at least one wireless data communication gateway is associated with a tower.

In one aspect, the at least one wireless data communication gateway is mobile.

In one aspect, the at least one wireless data communication gateway is associated with a drone.

In one aspect, a plurality of wireless data communication gateways are utilized in the system in order to extend a coverage range.

In one aspect, data collected by the at least one wireless data communication gateway is stored locally at the at least one wireless data communication gateway.

In one aspect, data collected by the at least one wireless data communication gateway is stored at a remote location and accessed through an online interface.

In one aspect, the data communication module stores a unique node identifier such that the powered module can be individually addressed separate from other powered modules.

In one aspect, the microcontroller is incorporated into the data communication module.

In one aspect, the initiation device includes controls for playback of the media message, wherein the controls include one or more of play, pause, fast-forward, rewind, next message, on and off.

In one aspect, the flexible printed circuit assembly further includes a memory integrated circuit which is configured to capture an extended duration message.

In one aspect, the memory integrated circuit is an EEPROM.

In one aspect, the flexible printed circuit assembly further includes an audio amplifier integrated circuit to decrease loading on an output of the microcontroller and/or to filter an audio signal.

In one aspect, the flexible printed circuit assembly further includes a global positioning system (GPS) antenna and a GPS integrated circuit, wherein the GPS antenna is configured to collect a signal from GPS satellites, and wherein the GPS integrated circuit is configured to collect relevant GPS location and time data from a constellation of GPS satellites through the GPS antenna.

In one aspect, the GPS antenna is either a passive device or an active device.

In one aspect, the GPS integrated circuit is configured to return velocity.

In one aspect, the flexible printed circuit assembly further includes a remote charging antenna and rectifying circuit to charge the power-limited source or power the microcontroller.

In one aspect, the flexible printed circuit assembly further includes a component that is connected to every on-board integrated circuit or actively powered antenna in order to turn power on or off to those parts.

In one aspect, the component is a field-effect transistor.

In one aspect, the field-effect transistor is a MOSFET.

In one aspect, the flexible printed circuit assembly further includes a sensor, sensor integrated circuit, or sensor array to collect data at a location of the powered module.

In one aspect, the microcontroller can be programmed or reprogrammed remotely.

In one aspect, the flexible printed circuit assembly is configured to have both uplink and downlink data transmission capabilities.

In one aspect, the programmed media message can be reprogrammed.

In one aspect, a powered module can include a top substrate; a bottom substrate; and a circuit assembly, the circuit assembly being positioned between the top substrate and the bottom substrate, the circuit assembly including, a circuit board, a microcontroller associated with the circuit board, the microcontroller having a media message programmed therein, a power source of electrical energy associated with the circuit board, a playback device associated with the circuit board, the playback device being configured to play the media message, an initiation device associated with the circuit board, the initiation device being configured to cause the playback device to play the media message, and a data communication module and an associated data communication antenna, wherein the data communication module is configured to transmit and/or receive data wirelessly, each of the microcontroller, the power source, the playback device, the initiation device, the data communication module and the data communication antenna being electrically connected to one another.

In one aspect, a system for utilizing media modules can include a plurality of media modules, each media module having a circuit assembly which includes a microcontroller and a data communication assembly, wherein the data communication assembly is configured to receive data from the microcontroller, and wherein the data communication assembly is configured to transmit data to the microcontroller; and at least one wireless data communication gateway, wherein the data communication assembly and the at least one wireless data communication gateway are configured to transmit and receive data between one another using a low-range, low-power communication protocol.

In one aspect, a method of transmitting data to at least one media module can provide at least one media module, each media module having a circuit assembly which includes a microcontroller and a data communication assembly; provide at least one wireless data communication gateway; transmit data from the at least one wireless data communication gateway to the data communication assembly of each media module using a low-range, low-power communication protocol; and transmit the data received from the at least one wireless data communication gateway from the data communication assembly to the microcontroller of each media module.

In one aspect, a method of transmitting data from at least one media module can provide at least one media module, each media module having a circuit assembly which includes a microcontroller and a data communication assembly; providing at least one wireless data communication gateway; transmitting data from the microcontroller of each media module to the data communication assembly of each media module; and transmitting data from the data communication assembly of each media module to the at least one wireless data communication gateway using a low-range, low-power communication protocol.

In one aspect, a method of dissemination of a media message in mass by means of an airdrop to an identifiable target area can identify the target area; provide a plurality of modules containing a circuit assembly, the circuit assembly configured to store a media message therein and to play the media message stored therein upon activation of the circuit assembly; distribute in mass the plurality of modules to the target area by means of the airdrop; and after distribution, broadcasting a first media message to one or more of the plurality of modules to be stored by the circuit assembly such that the first media message can thereafter be played upon activation of the circuit assembly.

In one aspect, the broadcasting of the first media message occurs after the airdrop has occurred, but before the plurality of modules have landed in the target area.

In one aspect, the broadcasting of the first media message occurs after the airdrop has occurred, and after the plurality of modules have landed in the target area.

In one aspect, further broadcasting a second media message to a predetermined set of the plurality of modules when it is determined that the predetermined set of the plurality of modules did not land in the target area, wherein the second media message is different than the first media message.

In one aspect, further broadcasting a second media message to a predetermined set of the plurality of modules when it is determined that the predetermined set of the plurality of modules has been moved from the target area to a non-target area, wherein the second media message is different than the first media message.

In one aspect, further broadcasting a second media message to a predetermined set of the plurality of modules, wherein the second media message is different than the first media message, and wherein the broadcasting of the second media message occurs after the first media message has been played.

In one aspect, further broadcasting a second media message to a predetermined set of the plurality of modules, wherein the second media message is different than the first media message, and wherein the broadcasting of the second media message occurs prior to the first media message having been played.

In one aspect, further broadcasting a second media message to a predetermined set of the plurality of modules, wherein the second media message is different than the first media message, and wherein the broadcasting of the second media message causes the first media message to be erased from the circuit assembly.

In one aspect, the activation of each circuit assembly occurs, such that the first media message is played, by an unfolding of the module containing the respective circuit assembly.

In one aspect, the flexible powered module can be folded, and the folding allows users to insert the powered module into envelopes, pants pockets, or other size-limited enclosures.

In one aspect, the activation of each circuit assembly occurs, such that the media message is played, by an initiation device of the circuit assembly being activated.

In one aspect, the initiation device of the circuit assembly comprises one or more of a button, a switch, and a sensor.

In one aspect, each module comprises a leaflet.

In one aspect, the circuit assembly is a flexible printed circuit assembly.

In one aspect, a method of dissemination of multiple media messages in mass by means of an airdrop to an identifiable target area can include identifying the target area; providing a plurality of modules, each module containing a circuit assembly, each circuit assembly configured to store one or more media messages therein and to play the one or more media messages stored therein upon activation of the circuit assembly; distributing in mass the plurality of modules to the target area by means of the airdrop; prior to the distribution in mass, pre-recording a first media message and storing the first media message in the circuit assembly of each module such that the first media message can thereafter be played upon activation of the circuit assembly; and after the distribution in mass, broadcasting a second media message to a predetermined set of the plurality of modules and storing the second media message in the circuit assembly of the predetermined set of the plurality of modules such that the second media message can thereafter be played upon activation of the circuit assembly, wherein the second media message is different than the first media message.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF DRAWINGS

FIG. 1 is a block diagram of an example powered module.

FIG. 2 is a block diagram of an example circuitry for another powered module.

FIG. 3 is a block diagram of an example communication gateway connected with the powered modules, e.g., to provide a downlink with the powered modules.

FIG. 4 is a block diagram of an example communication gateway connected with the powered modules, e.g., to provide an uplink with the powered modules.

FIG. 5 is a flowchart of an example process for using the powered module.

FIG. 6 is a flowchart of another example process for using the powered module.

FIG. 7 is a flowchart of another example process for using the powered module.

FIG. 8 is a block diagram of an example computing device of the powered modules.

### DESCRIPTION

An aspect of the present disclosure provides exemplary embodiments of a first powered module 120, where in some embodiments the powered module 120 can be utilized in a system 300 and method 310 along with a wireless data communication gateway 340, and in further connection with methods described herein. In some embodiments, the powered module 120 may be a power-limited media module. Fewer or additional features of the described with the powered module 120 can be used.

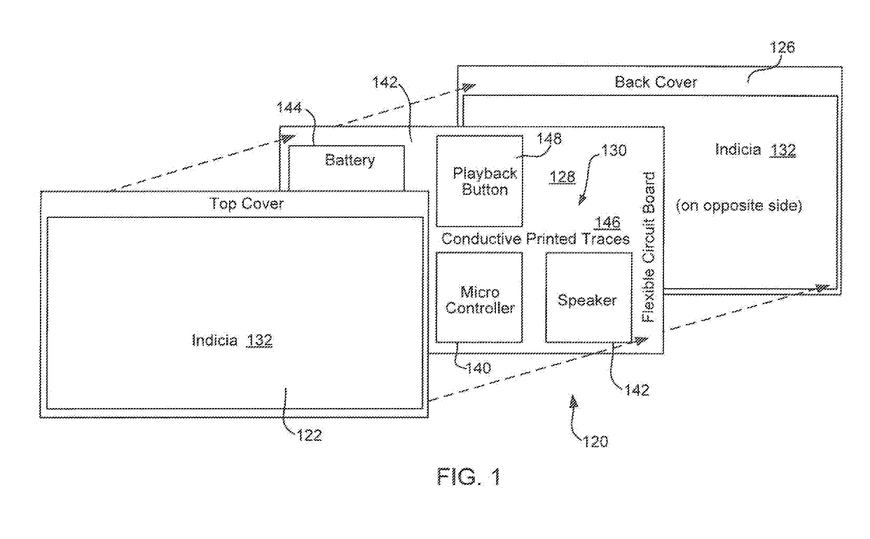

FIG. 1 is a block diagram of an example powered module 120. In one implementation the powered module 120 is a module for displaying media. In another implementation the module is power limited. The powered module 120 can include a first substrate layer 122, a second substrate layer 124 and a third substrate layer 126. The first substrate layer 122 and the substrate third layer 126 can be used to display print and images indicia 132 to a user and the second layer 124 can provide a substrate 128 for supporting circuitry 130 of the powered module 120. In one implementation, the substrate 128 includes a printed circuit board (PCB) to provide circuitry 130. The second layer 124 can be positionally sandwiched between the first layer 122 and the third layer 126, e.g., to protect the circuitry 130 from environmental elements. In some implementations, more or less layers can be used. The indicia 132 on the first layer 122 and third layer 126 can include one or more of pictures, diagrams, text, etc., displayed by one or more video and print, etc. Images can be placed on both the first layer 122 and third layer 126, on either the first layer 122 or third layer 126, or on neither the first layer 122 nor third layer 126, depending on an implementation. In some implementations the indicia 132 are used to provide a message to a recipient of the powered module 120. The circuitry 130 can include one or more of a microcontroller 140, speaker 142, a battery 144, conductive traces 146, and a playback button 148, etc. for playing programmed messages and/or other sounds and/or video when the playback button 148 is pressed or otherwise activated by a recipient of the powered module 120. In one example, the powered module 120 can play the programmed messages and/or other sounds and/or video at programmed periodic or random intervals. The messages and/or other sounds can relate to the indicia 132 displayed by the powered module 120. In one implementation the audio message relates to the text displayed to recipients that are unable to read the text.

In one implementation, the powered module 120 provides an advance in form factor by using advanced PCB manufacturing techniques to form printed electronic elements of the circuitry 130, for example, traces, overlays, and stenciled conductive epoxy of the circuitry 130. It will be appreciated that where PCB is described, it is described by way of non-limiting example, such that alternative assemblies on which circuitry and/or other electronic components may be substituted for PCB within the scope of the disclosure, including but not limited to point-to-point constructed circuits, application-specific integrated circuit (ASIC), field programmable gate array (FPGA), etc. By using printed conductive traces 146 on thin flexible polymer substrates, a reduction in the product package size requirements of a media-playing module can be achieved. That is to say, a flexible PCB can be inserted into an ultrathin product package to form thin lightweight and flexible powered modules 120 where the electronic elements are not obvious to observation by users. In some aspects, the flexible powered module 120 can be folded, and the folding allows the powered module 120 to be inserted into envelopes, pants pockets, or other size-limited enclosures.

Additionally, the powered module 120 can be fabricated to be sufficiently thin to pass through conventional inkjet and laser jet printers, allowing customizability of the package exterior by end users. Module compatibility with automatic feeding mechanisms on these printers can increase the throughput of customizing these distributed media modules.

The enhanced mechanical flexibility of the powered module 120 can represent a decrease in manufacturing complexity when compared to modern media modules, for example, electronic greeting cards, where multiple panels are connected by flexible cable interconnects. That is to say, less manual assembly is required to form distributed powered module 120 when all elements are located on the substrate 128.

The reduction in size and weight allow for an increase in capabilities for distributing the powered module 120.

Products that result from these manufacturing techniques are capable of meeting the functional requirements for electronic greeting cards, but also enable a new set of applications. Non-limiting applications envisioned by the thin, lightweight and flexible distributable powered modules 120 include, but are not limited to: remote-updateable media modules; time-varying animation displays; audio-enhanced electronic posters; transparent tamper detectors; low-visibility/camouflaged/benign-appearance electronic sensors and actuators; non-obvious listening devices; wrap-able cases for curved parts; shrinkable electronic enclosures; high aerodynamic drag objects; high transparency objects such as window-mounted sensors; heads-up display elements; immersive audio applications with a multitude of audio channels; hat or helmet-based sensing or actuation; interactive product stands or signage; human traffic monitoring, location determination; non-obvious use monitoring of seemingly passive media; asset theft detectors; parcel tracking; livestock tracking; audio books or booklets; individual-dependent personalized messaging; personal reminder devices; electronic tags; and windshield-mounted electronic elements.

In FIG. 1, an exemplary embodiment of the powered module 120 can include a power-limited media module that is capable of playing a programmed media message. The powered module 120 can include a flexible PCB which is formed of a flexible polymer substrate 128 having conductive traces 146 printed thereon. The powered module 120 further includes the microcontroller 140 or logic controller (which can be considered as equivalents in the context of this disclosure), a power-limited source of electrical energy, e.g., battery 144, a playback device, e.g., speaker 142, for playing the programmed media message, an initiation device, e.g., playback button 148, for causing the playback device to play the programmed media message, the top substrate layer 122, and the bottom substrate layer 126.

The microcontroller 140 can be programmed to execute determined behavior, such as the recording of the programmed media message and the replay of the programmed media message. If desired, the microcontroller 140 may be programmed to monitor local conditions and/or count the number of times that the media message has been played. The microcontroller 140 has the capability to enter and exit a low power sleep mode. Example microcontrollers 140 include MSP430FR5739 and variants thereof sold by Texas Instruments. Other examples can include, but are not limited to, PIC24FJ128GC006-I/PT by Microchip Technology, S1C17F57F401100 by Epson Electronics, and PSOC5LP by Cypress Semiconductor, etc. The microcontroller 140 can be mounted on the flexible PCB substrate 128 and electrically connected to the conductive traces 146 printed on the flexible PCB substrate 128.

The power-limited source of electrical energy can include one or more thin flexible batteries 144, although it is to be understood that other power-limited sources can also be utilized. The power-limited source can be mounted on the flexible PCB substrate 128 and electrically connected to the conductive traces printed on the flexible PCB. The power-limited source may alternatively be printed on the flexible PCB along with the conductive traces.

The playback devices can include one or more audio playback devices and/or a visual playback devices. In one embodiment, the audio playback device is speaker 142, but it is to be understood that any other suitable audio playback device can be utilized. In one embodiment, the visual playback device is a video display, but it is to be understood that any other suitable visual playback device can be utilized. For example, the speakers 142 can play media messages as audio messages. If the media message includes both an audio message and a visual message, then both an audio playback device and a visual playback devices can be included in the circuitry 130. The playback device is preferably mounted on the flexible PCB and electrically connected to the conductive traces 146 printed on the flexible PCB. The playback device may alternatively be printed on the flexible PCB along with the conductive traces 146.

The initiation device preferably includes one or more playback buttons 148 or switches which, when touched or moved or otherwise activated, can cause the playback device to play the programmed media message. Playback and button controls 148 can include, but are not limited to, a membrane switch such as those fabricated by Molex, a metal dome switch such as the SwitchAir by Nicomatic, a sliding switch such as the JS202011SCQN by C&K Components, etc. It is to be understood that, while the initiation device is described as including one or more buttons 148 or switches, the initiation device can also be configured in any other manner so long as the initiation device can be made to initiate the playback of the media message. For instance, the initiation device can be a device that is configured to receive audio instructions to cause the playback device to play the programmed media message. Additionally or alternatively, the initiation device can be one or more sensors which are configured to cause the playback device to play the programmed media message upon certain conditions, e.g., pressure, temperature and/or movement, etc., being sensed. The initiation device is preferably mounted on the flexible PCB substrate 128 and electrically connected to the conductive traces 146 printed on the flexible PCB substrate 128. The initiation device may alternatively be printed on the flexible PCB substrate 128 along with the conductive traces 146.

Once the flexible PCB substrate 128, the conductive traces 146, the microcontroller 140, the power-limited source, e.g., battery 144, the playback device, e.g., speaker 142, and the initiation device, button 148, are all mounted together and electrically connected together, a flexible printed circuit assembly (FPCA) is formed. It is to be understood that any of the conductive traces 146, the microcontroller 140, the power-limited source, e.g., battery 144, the playback device, e.g., speaker 142, and the initiation device, e.g., playback button 148, can be provided on one or both sides of the flexible PCB substrate 128.

The FPCA can be positioned between, and generally encapsulated by, the top substrate 122 and bottom substrate 126 in order to, in essence, house the FPCA therebetween and, thereby, protect the FPCA. One or both of the top substrate 122 and bottom substrate 126 may have one or more openings provided therethrough in order to provide audio or visual access to the playback device, e.g., such that the media message can be better seen or heard or both. Additionally or alternatively, with regard to a media message, e.g., indicia 132, that is to be seen, one or both of the top substrate 122 and bottom substrate 126 can be formed of a clear or translucent material such that the media message can be viewed without needing to provide openings through the top substrate 122 or bottom substrate 126. One or both of the top substrate 122 and bottom substrate 126 may have one or more openings provided therethrough in order to provide physical access to the initiation device, e.g., playback button 148, to play the media message. The top substrate 122 and bottom substrate 126 may be formed of any suitable material. The top substrate 122 and bottom substrate 126 are preferably formed of a material which can have indicia 132 (e.g., text, images, etc.) printed thereon. The top substrate 122 and bottom substrate 126 can be formed of a material which is thin, lightweight and/or flexible.

The powered module 120 may also be able to be mounted or affixed to a further substrate, such as a wall or a table. In this regard, the bottom substrate 126 may also have, for instance, an adhesive applied to a back side thereof (opposite the side which abuts the FPCA) and a liner covering the adhesive. When the powered module 120 is to be affixed in a location, such as on a wall, the liner can be removed and the adhesive positioned against the wall so as to adhere the powered module 120 to the wall. Additionally or alternatively, a back side of the top substrate 122 (the side which abuts the FPCA) can have an adhesive or the like applied thereto (around, and preferably not touching, the FPCA) and the bottom substrate 126 can be a liner covering the adhesive and the FPCA. When the powered module 120 is to be affixed in a location, such as on a wall, the liner can be removed and the adhesive positioned against the wall (and the FPCA facing or abutting the wall) so as to adhere the powered module 120 to the wall.

The powered module 120 can be provided in any number of different forms.

As a first example, the powered module 120 can be utilized in an electronic greeting card, such as a birthday card, having top and bottom panels providing a V-fold, where each of the top and bottom panels has indicia 132 printed thereon. The bottom panel can be in the form of the powered module 120, namely having top substrate 122 and bottom substrate 126 having the FPCA provided therebetween. Thus, the top substrate 122 and bottom substrate 126 can be formed of a thick card-stock paper. The microcontroller 140 can be programmed with a full-length or partial-length song, such as “Happy Birthday”. Alternatively, the powered module 120 can be configured such that the user of the greeting card can record his/her own message for playback. The playback device may be a speaker 142 and the initiation device may be a playback button 148. The top substrate 122 of the bottom panel may have one or more openings provided therethrough which allow for the sound emanating from the speaker to be broadcast out of the powered module 120. The top substrate 122 of the bottom panel may also have an opening provided therethrough which allows for the button to be contacted in order to initiate the playback of the recorded audio message via the speaker. Alternatively, the powered module 120 can be configured such that the playback of the recorded audio message can be initiated upon the opening of the electronic greeting card, e.g., by moving the top panel away from the bottom panel.

For powered modules 120, including electronic greeting cards, that are purchased individually, the reduced product package size and weight presents the opportunity to reduce shipping costs and this directly contributes to enhanced usability as a distributable module.

As a second example, the powered module 120 can be utilized as a leaflet for advertising at a store or the like. The leaflet can be given to customers as they enter the store or at other designated locations. The leaflet can also be provided in the form of a mailer such that the leaflet can be mailed to potential customers. The leaflet can have indicia 132 printed on one or both of the top substrate 122 and bottom substrate 126, e.g., information regarding the name of the store, the location of the store, the phone number of the store, the store's website, the articles being sold, etc. The leaflet can be provided with programmed audio or video messages to alert customers to potential sales in stores.

As a third example, the powered module 120 can be utilized as an airdropped leaflet/booklet. For modules that are airdropped, the reduction in size and weight of the module represents the ability to disseminate a message contained in the media module over greater distances and to more individuals. Where the powered module 120 is used as an airdropped leaflet/booklet, the powered module 120 can be capable of surviving an impact resulting from the airdrop, thus the use of the FCPA becomes further advantageous for the powered module 120 due to the reduced weight associated with the powered module 120 as opposed to prior art modules. Furthermore, where the powered module 120 is used as an airdropped leaflet/booklet, the powered module 120 can be capable of surviving extended exposure to adverse elements of nature for a predetermined period of time, for example at least three days.

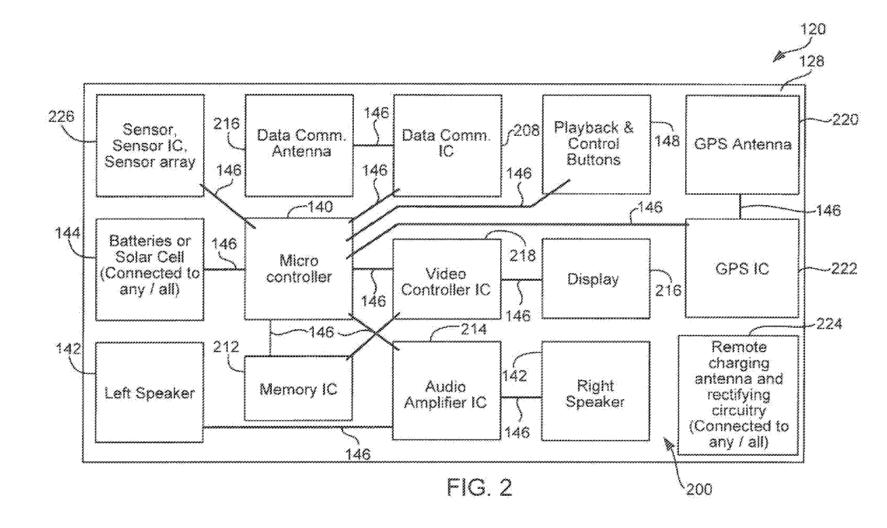

FIG. 2 is a block diagram of an example circuitry for another powered module 120. While the powered module 120 in FIG. 1 may provide a simple embodiment of a distributable media module, a further embodiment of a distributable media module is provided by powered module 120 with reference to FIG. 2. The powered module 120 can generally include elements associated with the powered module 120 of FIG. 1, but also includes other elements and may generally be used where power is not a primary limitation. It is to be noted that while the powered module 120 is described herein as using an FCPA 200, the powered module 120 can also, alternatively, use a circuit assembly which is not an FPCA.

The FPCA 200 of the powered module 120 may, for example, include a data communication module 208, such as a data communication integrated circuit (IC), which is capable of transmitting and receiving data wirelessly. For example, this data can be transmitted or received using a long-range, low-power communication protocol, such as Long Range (LoRa), or a long-range RF data transmission protocol, such as Global System for Mobile Communications (GSM) or Time Division Multiple Access (TDMA).

If a data communication module 208 is provided, the FPCA 200 of the powered module 120 can also include a data communication antenna 210. The data communication antenna 210 can be either implemented as a discrete part or as printed trace on the flexible PCB substrate 128. The data communication antenna 210 may be either a passive or active device. The microcontroller 140 may be incorporated into the data communication module 208 or the microcontroller 140 may be a discrete element that is separate from the data communication module 208. Example data communication antennas 210 include, but are not limited to, a trace on the printed circuit board in a configuration such as a planar inverted F-shaped antenna (commonly called PIFA) or meandering trace antenna, a chip antenna such as 2450AT42A100E by Johanson Technology, and/or a trace on an attached data communication module such as the LL-RLP-20-915-SYM-A by Link Labs or WRL-13678 by SparkFun Electronics, etc. Example data communication modules 208 include, but are not limited to, RF modules that include the data communication antenna 210, e.g., LL-RLP-20-915-SYM-A by Link Labs or WRL-13678 by SparkFun Electronics. Alternatively the data communication module 208 may be placed directly onto the module substrate 128, e.g., the Espressif ESP8266 or the Semtech SX1276. If the data communication module 208 is placed directly onto the substrate 128, then it may require a supplemental memory module, e.g., the AT25SF041 by Adesto Technologies to hold buffer data or configuration data.

The FPCA 200 of the powered module 120 may, for example, include additional batteries and/or solar cells 144 to scavenge available energy. Batteries or solar cells 144 can include, but are not limited to, coin cell, e.g., the CR2032 by Energizer, Ultra-thin primary cells such as the CF042039(N) by FDK, Ultra-thin cells printed onto or attached to the substrate 128 e.g., the SoftBattery by Enfucell, ultra-thin rechargeable cells, e.g., the customizable ZincPoly series by Imprint Energy, larger polymer pouch cells e.g., offerings from PowerStream and solar cell which may be flexible. These flexible options can include the flexible ELO-based GaAs offerings from Alta Devices or the flexible silicon offerings from PowerFilm.

The FPCA 200 of the powered module 120 may, for example, include additional buttons 148 to control playback of the media message including, but not limited to: play, pause, fast-forward, rewind, next message, on or off.

The FPCA 200 of the powered module 120 may, for example, include a memory integrated circuit (IC) 212, e.g., a read-only memory (ROM) whose contents can be erased and reprogrammed using a pulsed voltage, commonly referred to as EEPROM. Additionally or alternatively, the memory can include program memory, a cache, random access memory (RAM), a flash memory, a hard drive, etc., and/or other types of memory. In some embodiments, the memory IC 212 can store instructions (e.g., compiled executable program instructions, uncompiled program code, some combination thereof, or the like)), which when performed (e.g., executed, translated, interpreted, and/or the like) by the microcontroller 140, causes the microcontroller 140 to perform processes described herein. Additionally or alternatively, the memory IC 212 can be configured to capture an extended duration message. Memory ICs 212 can include, but are not limited to non-volatile memory modules, e.g., the AT24CM01-SSHM-B from Atmel (EEPROM memory type) and volatile memory modules, e.g., 23K256-USN by Microchip (SRAM memory type).

The FPCA 200 of the powered module 120 may, for example, include stereo audio as implemented by separated left and right speakers 142. Example speakers 142 can include, but are not limited to, piezoelectric ceramic offerings, e.g., APS2709S-T-R from PUI Audio Inc., and/or PVDF printed films by Molex. The FPCA 200 of the powered module 120 may, for example, further include an audio amplifier IC 214 to decrease loading on the microcontroller output and/or to filter the audio signal. The audio amplifier IC 214 can include, but is not limited to, LM48860TL/NOPB from Texas Instruments.

The FPCA 200 of the powered module 120 may, for example, include a video display 216 for a static image, animated frames, or full speed video. This display 216 may be bi-stable to reduce power, if desired. The FPCA 200 of the powered module 120 may, for example, further include a video controller IC 218 to interpret video information from the microcontroller 140 and to pass the video information to the display 216. A display 216, which is preferably low-power, can include, but is not limited to, a segmented electrophoretic display, e.g., SC005221 by E-Ink Corporation, a pixelated electrophoretic display such as options printed by Molex, and a bar gauge such as SC002221 by E-Ink Corporation, etc. A video controller IC 218 can include, but is not limited to, PIC24FJ128GC006-I/PT by Microchip Technology and S1C17F57F401100 by Epson Electronics, etc.

The FPCA 200 of the powered module 120 may, for example, include a GPS (global positioning system) antenna 220 and GPS IC 222. The GPS antenna 220 can be configured to collect a signal from GPS satellites. The GPS antenna 220 may be either a passive or active device. The GPS IC 222 can be configured to collect relevant GPS location (latitude, longitude, altitude) and time data from a constellation of GPS satellites through the GPS antenna 220, e.g., to be processed by the microcontroller 140. The GPS IC 222 can also be configured to return velocity to the microcontroller 140. The GPS antenna 220 may include, but is not limited to, a trace on the printed circuit board in a configuration such as a planar inverted F-shaped antenna (commonly called PIFA) or meandering trace antenna and a chip antenna, e.g., the 1575AT43A0040E by Johanson Technology, etc. The GPS IC 222 may include, but is not limited to, the RXM-GPS-RM-T by Linx, alternately called an RF receiver.

The FPCA 200 of the powered module 120 may, for example, include a remote charging antenna and rectifying circuit 224 to charge batteries 144 or power the microcontroller 140. The remote charging and rectifying circuit 224 can include, but is not limited to a discrete component including resistors, capacitors, inductors, and diodes connected to a set of printed traces on the substrate 128. The trace geometries 146 may also be tuned for desirable antenna performance parameters.

The FPCA 200 of the powered module 120 may, for example, include a component, such as a field-effect transistor, for example a MOSFET, that is connected to every on-board IC or actively powered antenna, in order to turn power on or off to those parts.

The FPCA 200 of the powered module 120 may, for example, include a sensor, sensor IC, or sensor array 226 to collect data at the location of the powered module 120. A wide variety of types of data can be collected by using sensor, sensor IC and/or sensor array 226 on the powered modules 120, e.g., depending on the sensor type that is included on the module. The sensor data types can include but is not limited to temperature, humidity, vibration, mechanical shock/drop, voltage, current, magnetic field, battery health, location, lifetime, light (IR, UV, visible), radio frequency (RF) signal strength, proximity, capacitance, time, number of times that the module has been played, number of times that a button has been pressed, sound, pressure, force, weight, acceleration, chemical concentration, chemical type, solution pH, gas concentration, and/or gas type, etc. Sensor, sensor IC, sensor array 226 may include a plurality of sensors, depending on configuration of the powered module 120. Example parts include, but are not limited to, TSOP4136 infrared photodiode by Vishay, LTR-329ALS-01 ambient light sensor by Lite-On, SHT25 temperature and humidity sensor IC by Sensirion, ADXL335 MEMS accelerometer by Analog Devices, PKGS-00LDP1-R by Murata Electronics, printed silicon thermistor array by PST, Inc., and/or printed pressure array by Molex, etc.

Example applications for sensor, sensor IC and/or sensor arrays 226 that can be included in the powered modules 120 includes, but is not limited to, remote-updateable media modules, time-varying animation displays, audio-enhanced electronic posters, transparent tamper detectors, low-visibility/camouflaged/benign-appearance electronic sensors and actuators, non-obvious listening devices, wrap-able cases for curved parts, shrinkable electronic enclosures, high aerodynamic drag objects, high transparency objects such as window-mounted sensors, heads-up display elements, immersive audio applications with a multitude of audio channels, hat or helmet-based sensing or actuation, interactive product stands or signage, human traffic monitoring, location detection, non-obvious use monitoring of seemingly passive media, asset theft detectors, parcel tracking, parcel health monitoring, smart packaging or labeling, livestock tracking, audio books or booklets utilization, individual-dependent personalized messaging, personal reminder devices, proximity tags, windshield-mounted electronic elements, pulse rate sensing, NFC data readout patches, and/or soil condition sensors, etc.

The FPCA 200 of the powered module 120 can, if desired, include further components, and, if desired, can be configured to have the full functionality of a cellular telephone.

The powered modules 120 can be configurable to be programmed remotely, with both uplink and downlink data transmission capabilities. The onboard data communication transceiver enables data collection from the set of media modules after they have entered use, and the media message can be reprogrammed on individual modules or on the set of all modules within transmission range.

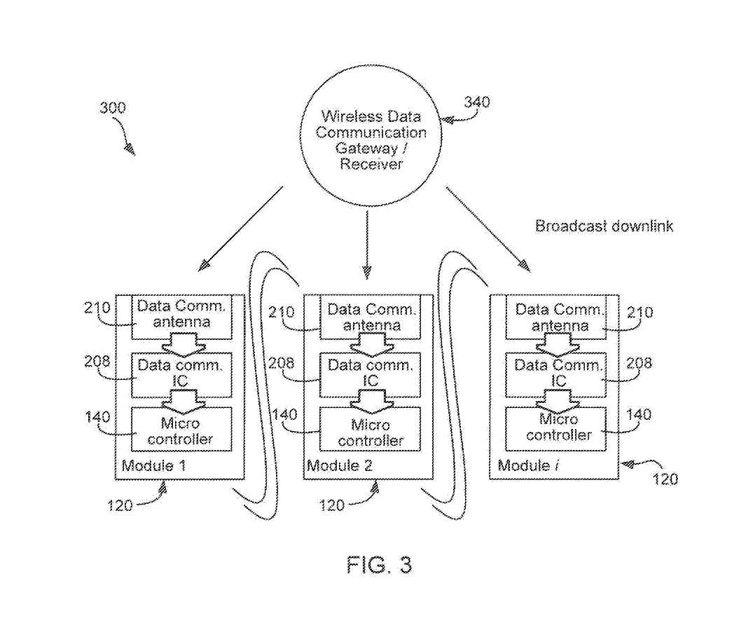

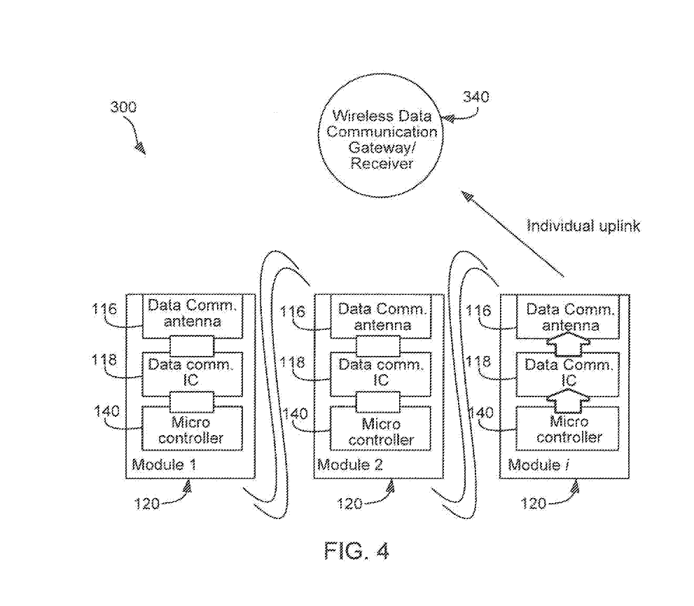

FIGS. 3 and 4 are block diagrams of an example communication gateway 340 connected with the powered modules 120. A system 300 and method 310 can include a plurality of powered modules 120 and the communication gateway 340. For the sake of explanation, the communication gateway 340 is described making a wireless connection with the powered modules 120. It should be appreciated that data communicated between the communication gateway 340 and the powered modules 120 can include one or more wireless or wired connections. Example connection types include, but are not limited to universal serial bus (USB), FireWire, Thunderbolt, Lightning, serial communications ports, parallel communications ports, Ethernet (RJ-45 connector), and/or other wired communication types that may be used to physically interface the communication gateway 340 with the powered modules 120. Wireless connections can includes, but are not limited to, BLUETOOTH™, IEEE 802.11 Wi-Fi, satellites, cellular communications, etc.

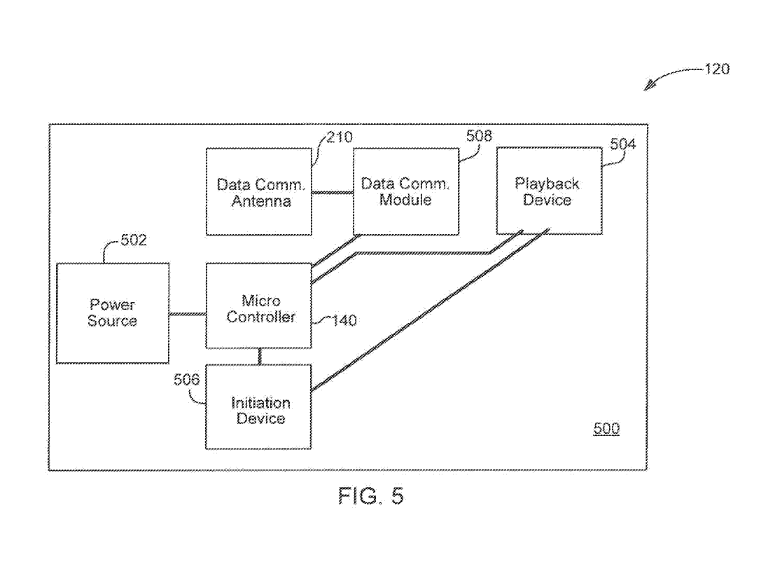

The configuration and use of the system 300 and method 310 is described and illustrated herein with reference to FIGS. 3 and 4. In connection with the configuration and use of system 300 and method 310, a set of distributed powered modules 120, e.g., module 1, module 2, through module i, can be manufactured, and the information stored on these modules can either be pre-programmed and/or they can be programmed after deployment by using a broadcast downlink. With regard to FIG. 5, circuitry of the powered module 120 may include elements of the FPCA 200, but in some embodiments can have a circuit assembly which includes at least a circuit board 500, a microcontroller 140, a power source of electrical energy 502, a playback device 504, an initiation device 506, a data communication module 508, and a data communication antenna 210. The microcontroller 140 may be incorporated into the data communication module 508 or the microcontroller 140 may be a discrete element that is separate from the data communication module 508. The circuit board 500 can be of the type as previously described herein, e.g., a flexible PCB having conductive traces printed thereon, such that the form factor and cost-savings associated therewith may be achieved. The power source 502, playback device 504, initiation device 506 and data communication module 508 can also be of the types described herein, or other types. It is not necessary for the system 300 and method 310 to utilize such an FPCA and the disclosure described and illustrated herein should not be so limited. Also, it is not necessary for the system 300 and method 310 to utilize a power-limited source of electrical energy and the disclosure described and illustrated herein should not be so limited.

The desired message is provided to the wireless data communication gateway 340 and a message can be transmitted either to the full set of modules 120 or to a limited set of modules 120. The powered modules 120 can be individually addressable through the use of a unique identifier stored in the data communication IC, microcontroller, or onboard memory. To ensure that the message data is successfully transmitted, the modules may acknowledge the receipt of the message. To capture multiple messages into the onboard memory, a file system may be employed. More than one wireless data communication gateway 340 may be used to ensure coverage of the area where modules 120 are located. Additionally or alternatively, the wireless data communication gateways 340 may be supplemented with wireless data communication repeater units. The repeaters can have lower electrical power requirements, and relay data to other repeaters or gateways. Many types of messages can be broadcasted to extend functionality of the set of modules 120 including keep-alive timers, activate/deactivate modules, changes from one message to another, or transmission of a new or updated message.

Data downlinked to and uplinked from powered modules 120, individually or collectively, can also be collected sequentially. The set of modules 120 can either be interrogated by a request from the wireless data communication gateway 340 or spontaneously transmitted to report information collected from the onboard sensors or sensor ICs 226, or microcontroller 140. The set of modules 120 may be configured to avoid transmitting data unless the modules 120 have started their usable lifetime. In some embodiments, the modules 120 may be synchronized to avoid packet collision and to optimize power utilization. The individual uplink capability of the distributed powered modules 120 directly enables the capability to track the position of any module 120 of interest.

A set of multiple wireless data communication gateways 340 can be used to extend the coverage range. Data from the modules 120 that has been received by the gateway 340 can be stored locally at the gateway 340 or collected with data from additional modules 120 at a remote location and accessed through an online interface. The gateway(s) 340 may be mobile or kept at a fixed position.

The system 300 and method 310 can be provided in any number of different forms.

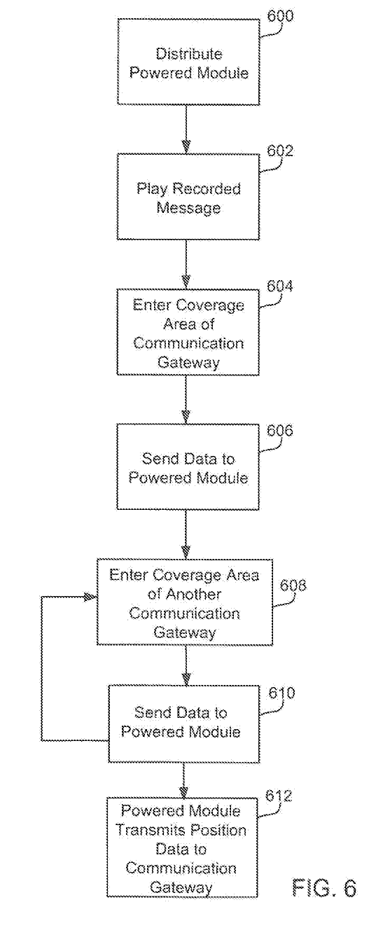

FIG. 6 is a flowchart of an example process for using the powered module 120. As a first example, the system 300 and method 310 can be utilized in connection with powered modules 120 in the form of a mailer for a mall, where the mall has one or more wireless data communication gateways 340 associated with it. For example, if the mall has a parking lot, a pair of department stores, and a plurality of smaller retail stores in locations provided between the pair of department stores, four wireless data communication gateways 340 can be associated with the mall, one which has a range covering the parking lot, one which has a range covering a first one of the department stores, one which has a range covering a second one of the department stores, and one which has a range covering the smaller retail stores.

In practice, a powered module 120 can be distributed, e.g., in the form of a mailer can be mailed to a potential customer's residence (600). The powered module 120 can have some printed indicia 132 on it, e.g., information regarding the mall, including information regarding the stores at the mall, the location of the mall, etc. The powered module 120 can also be provided with a recorded media message which can be activated/initiated by the potential customer upon his/her receipt of the mailer (602). The media message can advise the potential customer of extreme sales taking place at the mall on a certain day and instructing the potential customer to bring the mailer with him/her to the mall that day to learn more about the extreme sales.

When the potential customer brings the mailer to the mall on the designated day, the potential customer enters the mall through the first one of the department stores. Upon entering the first one of the department stores, the powered module 120 is within range of the associated wireless data communication gateway 340 and can send an uplink communication to the associated wireless data communication gateway that the mailer is within the coverage area (604). The associated wireless data communication gateway 340 can then send a broadcast downlink to the powered module 120, e.g., mailer, to provide a new media message, e.g., the holder of the mailer can receive 50% off on certain merchandise in the store (606). When purchasing the identified merchandise, the media message may include an appropriate coupon code, barcode, or the like to allow for the discount to be applied at the register.

When the customer exits the first department store and enters the area with the smaller retail stores, the mailer is within range of the associated wireless data communication gateway 340 and can send an uplink communication to the associated wireless data communication gateway 340 that the powered module 120 is within the coverage area (608). The associated wireless data communication gateway 340 can then send a broadcast downlink to the mailer to provide a new data, e.g., media message, so the holder of the mailer can be alerted to a sale occurring in one of the smaller retail stores, and provide a visual map of the location of the smaller retail store relative to the two department stores and the parking lot (610). The powered module 120 can transmit its position to the communication gateway 340, e.g., so that the position data can be collected and interpreted by a remote user (612).

When the customer enters the second department store, the mailer is within range of the associated wireless data communication gateway and can send an uplink communication to the associated wireless data communication gateway that the mailer is within range. The associated wireless data communication gateway can then send a broadcast downlink to the mailer to provide a new media message, e.g., the holder of the mailer can receive a percentage of cash back on every purchase dollar spent to be applied toward a future visit to the second department store. When purchasing the identified merchandise, the media message may include an appropriate coupon code, barcode, or the like to allow for the promotion to be applied at the register such that the customer can receive the coupon or the like to be used at a future visit.

When the customer exits the mall and returns, for instance, to his/her car in the parking lot, the mailer is within range of the associated wireless data communication gateway and can send an uplink communication to the associated wireless data communication gateway that the mailer is within range. The associated wireless data communication gateway 340 can then send a broadcast downlink to the mailer to provide a new media message, e.g., a coupon for a future visit to the mall or a coupon to a restaurant located near the mall, but which is ultimately still within the range of the associated wireless data communication gateway. Alternatively, the associated wireless data communication gateway can deactivate the power to the mailer, such that the powered module 120, e.g., mailer cannot be utilized by persons other than the designated potential customer.

In this example, the wireless data communication gateway 340 can preferably take the form of a fixed position gateway, e.g., a gateway provided on a radio tower.

It is to be understood that the media messages identified above in the example are just exemplary, such that other media messages can be provided. It is also to be understood that not every powered module 120, e.g., mailer than enters the mall receive identical media messages when they are in identical locations. The media messages can be random, or can be defined based on other known information, e.g., the potential customer's past purchasing behavior.

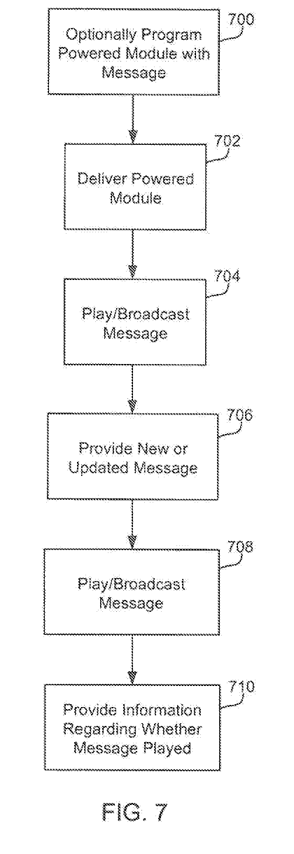

FIG. 7 is a flowchart of another example process for using the powered module 120. As a second example, the system 300 and method 310 can be utilized in connection with powered modules 120 in the form of delivered, e.g., air-dropped, leaflets. The air-dropped leaflets can be provided with any programmed media message which is deemed important enough for the dropping of the leaflets, for example, information regarding an upcoming event and possible suggested action/inaction to be taken in preparation for the upcoming event (700). Alternatively, and potentially advantageously, the leaflets can be air-dropped prior to having a message programmed therein (702). The leaflets can then be programmed soon after they have been air-dropped, but before they land, (thereby ensuring the exact location of the air-dropping of the leaflets (or sets of leaflets), or can be first programmed at some point in time after the leaflets have landed. Once the event has occurred, e.g., the message played and/or broadcast (704), the wireless data communication gateway(s) 340 can send a broadcast downlink to each of the air-dropped leaflets within its range to provide an updated media message, which message can include information relating to the now past event and/or information regarding to a new upcoming event and possible suggested action/inaction to be taken in preparation for the new upcoming event. Additionally or alternatively, a new message can be loaded to the powered module 120 (706). The new message can also be played and/or broadcast (708).

On the flip side, the air-dropped leaflets can send uplink information to the wireless data communication gateway(s) 340 to provide information, such as whether the media message was played and, if the leaflets were provided with location-determining capability, where the leaflets have been taken as compared to where they were dropped (710).

In this example, the wireless data communication gateway 340 can take the form of a mobile gateway, e.g., a gateway provided in association with, for example, a drone. Depending on the size of the area where the leaflets were dropped, the wireless data communication gateway 340 may include a large plurality of gateways 340 in order to best cover the entire drop area and an expanded area beyond the drop area.

The system 300 and method 310 further provides for novel methods of dissemination of a media message in mass by means of an air drop to an identifiable target area. In a first embodiment, the method includes the steps of: (a) identifying the target area; (b) providing a plurality of powered modules 120 containing a circuit assembly, where the circuit assembly is configured to store a media message therein and to play the media message stored therein upon activation of the circuit assembly; (c) distributing in mass the plurality of powered modules 120 to the target area by means of the air drop; and (d) after distribution, broadcasting a first media message to one or more of the plurality of powered modules 120 to be stored by the circuit assembly such that the first media message can thereafter be played upon activation of the circuit assembly.

In an embodiment of the method, the broadcasting of the first media message occurs after the airdrop has occurred, but before the plurality of powered modules 120 has landed in the target area. In an alternative embodiment of the method, the broadcasting of the first powered module 120 occurs after the airdrop has occurred, and after the plurality of powered modules 120 has landed in the target area.

In another embodiment of the method, the method further includes the step of broadcasting a second media message to a predetermined set of the plurality of powered modules 120 when it is determined that the predetermined set of the plurality of powered modules 120 did not land in the target area, wherein the second media message is different than the first media message. In an alternative embodiment of the method, the method further includes the step of broadcasting a second media message to a determined set of the plurality of powered modules 120 when it is determined that the determined set of the plurality of powered modules 120 has been moved from the target area to a non-target area, wherein the second media message is different than the first media message.

In another embodiment of the method, the method further includes the step of broadcasting a second media message to a predetermined or conditional set of the plurality of powered modules 120, wherein the second media message is different than the first media message, and wherein the broadcasting of the second media message occurs after the first media message has been played. In another embodiment of the method, the method further includes the step of broadcasting a second media message to a predetermined or conditional set of the plurality of powered modules 120, wherein the second media message is different than the first media message, and wherein the broadcasting of the second media message occurs prior to the first media message having been played. In still another embodiment of the method, the method further includes the step of broadcasting a second media message to a predetermined set of the plurality of modules, wherein the second media message is different than the first media message, and wherein the broadcasting of the second media message causes the first media message to be erased from the circuit assembly.

In an alternative embodiment of the method, the activation of each circuit assembly occurs, such that the first media message is played, by an unfolding of the powered module 120 containing the respective circuit assembly. In another embodiment of the method, the activation of each circuit assembly occurs, such that the media message is played, by an initiation device of the circuit assembly being activated. The initiation device includes one or more of a button, a switch, and a sensor.

In an embodiment of the method, each powered module 120 includes a leaflet. In an alternative embodiment of the method, the circuit assembly of each powered module 120 is a flexible printed circuit assembly.

In a second embodiment, the method includes the steps of: (a) identifying the target area; (b) providing a plurality of powered modules 120, each powered module 120 containing a circuit assembly, each circuit assembly configured to store one or more media messages therein and to play the one or more media messages stored therein upon activation of the circuit assembly; (c) distributing in mass the plurality of powered modules 120 to the target area by means of the airdrop; (d) prior to the distribution in mass, pre-recording a first media message and storing the first media message in the circuit assembly of each module such that the first media message can thereafter be played upon activation of the circuit assembly; and (e) after the distribution in mass, broadcasting a second media message to a predetermined set of the plurality of modules and storing the second media message in the circuit assembly of the predetermined set of the plurality of powered modules 120 such that the second media message can thereafter be played upon activation of the circuit assembly, wherein the second media message is different than the first media message.

In an alternative embodiment of the method, the broadcasting of the second media message occurs after the airdrop has occurred, but before the predetermined set of the plurality of powered modules 120 has landed. More specifically, the broadcasting of the second media message may occur when it is determined that the predetermined set of the plurality of powered modules 120 will not land in the target area.

In another embodiment of the method, the broadcasting of the second media message occurs after the airdrop has occurred, and after the predetermined set of the plurality of powered modules 120 has landed. More specifically, the broadcasting of the second media message can occur: (1) when it is determined that the predetermined set of the plurality of powered modules 120 did not land in the target area; (2) when it is determined that the predetermined set of the plurality of modules has been moved from the target area to a non-target area; and/or (3) after the first media message has been played.

In yet another embodiment of the method, the broadcasting of the second media message occurs prior to the first media message having been played. In another embodiment of the method, the broadcasting of the second media message causes the first media message to be erased from the circuit assembly.

In another embodiment of the method, the activation of each circuit assembly occurs, such that one or both of the first and second media messages are played, by an unfolding of the module containing the respective circuit assembly. In another embodiment of the method, the activation of each circuit assembly occurs, such that one or both of the first and second media messages are played, by an initiation device of the circuit assembly being activated. The initiation device includes one or more of a button, a switch, and a sensor.

In an embodiment of the method, each module includes a leaflet. In an alternative embodiment of the method, the circuit assembly of each module is a flexible printed circuit assembly.

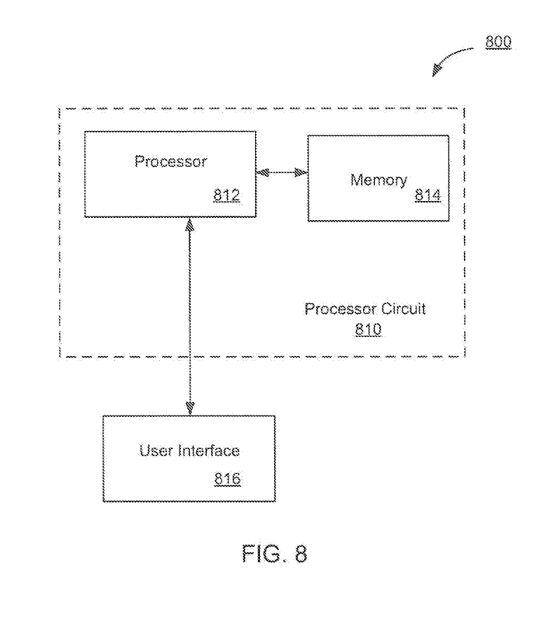

FIG. 8 is a block diagram of an example computing device 800 of the powered modules 120. The systems and methods described above may be implemented in many different ways in many different combinations of hardware, software firmware, or any combination thereof. In one example, the computing device 800 may enable functions of the powered module 120. It can be appreciated that the components, devices or elements illustrated in and described with respect to FIG. 8 below may not be mandatory and thus some may be omitted in certain embodiments. Additionally, some embodiments may include further or different components, devices or elements beyond those illustrated in and described with respect to FIG. 8.

In some example embodiments, the computing device 800 may include processing circuitry 810 that is configurable to perform actions in accordance with one or more example embodiments disclosed herein. In some examples the processing circuitry 810 includes the microcontroller 140 or other processor. The processing circuitry 810 may be configured to perform and/or control performance of one or more functionalities of the powered module 120. The processing circuitry 810 may be configured to perform data processing, application execution and/or other processing and management services according to one or more example embodiments. In some embodiments, the computing device 800 or a portion(s) or component(s) thereof, such as the processing circuitry 810, may include one or more chipsets and/or other components that may be provided by integrated circuits.

In some example embodiments, the processing circuitry 810 may include a processor 812 and, in some embodiments, such as that illustrated in FIG. 8, may further include memory 814. The processor 812 may be embodied in a variety of forms. For example, the processor 812 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it can be appreciated that the processor 812 may include a plurality of processors. The plurality of processors may be in operative communication with each other and may be collectively configured to perform one or more functionalities of the computing device 800 as described herein.

In some example embodiments, the processor 812 may be configured to execute instructions that may be stored in the memory 814 or that may be otherwise accessible to the processor 812. As such, whether configured by hardware or by a combination of hardware and software, the processor 812 is capable of performing operations according to various embodiments while configured accordingly.

In some example embodiments, the memory 814 may include one or more memory devices. Memory 814 may include fixed and/or removable memory devices. In some embodiments, the memory 814 may provide a non-transitory computer-readable storage medium that may store computer program instructions that may be executed by the processor 812. In this regard, the memory 814 may be configured to store information, data, applications, instructions and/or the like for enabling the computing device 800 to carry out various functions in accordance with one or more example embodiments. In some embodiments, the memory 814 may be in communication with one or more of the processor 812, the user interface 816 for passing information among components of the computing device 800. In some examples the user interface 816 includes the playback and control buttons 148.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

What is claimed is:

1. A powered module, comprising:
a top substrate;
a bottom substrate; and
a flexible printed circuit assembly, the flexible printed circuit assembly being positioned between the top substrate and the bottom substrate, the flexible printed circuit assembly including,
a flexible printed circuit board,
a microcontroller associated with the flexible printed circuit board, the microcontroller having a media message programmed therein,
a power-limited source of electrical energy associated with the flexible printed circuit board,
a playback device associated with the flexible printed circuit board, the playback device being configured to play the media message,
an initiation device associated with the flexible printed circuit board, the initiation device being configured to cause the playback device to play the media message, and
a plurality of conductive traces printed on the flexible printed circuit board which electrically interconnect the microcontroller, the power-limited source of electrical energy, the playback device, and the initiation device.

2. The powered module according to claim 1, wherein the power-limited source comprises one or more thin flexible batteries.

3. The powered module according to claim 2, wherein the power-limited source is printed on the flexible printed circuit board.

4. The powered module according to claim 1, wherein the power-limited source comprises one or more solar cells.

5. The powered module according to claim 1, wherein the playback device comprises a speaker printed on the flexible printed circuit board.

6. The powered module according to claim 1, wherein the programmed message is a visual message, and wherein the playback device is a video playback device.

7. The powered module according to claim 1, wherein the initiation device is one of a button, a switch, and a sensor.

8. The powered module according to claim 1, wherein the initiation device is printed on the flexible printed circuit board.

9. The powered module according to claim 1, wherein one or both of the top and bottom substrates have one or more openings provided therethrough in order to provide access to the playback device.

10. The powered module according to claim 1, wherein the powered module is configured to be fixed in place to a separate object, wherein the bottom substrate has an adhesive applied to a back side thereof, and a liner applied to the adhesive, wherein the liner can be removed such that the adhesive can be secured to the separate object, thereby securing the powered module to the separate object.

11. The powered module according to claim 1, wherein the powered module is utilized as an advertising leaflet or mailer.

12. The powered module according to claim 1, wherein the powered module is utilized as an air-dropped leaflet or booklet.

13. The powered module according to claim 1, wherein the flexible printed circuit assembly further includes a data communication module and an associated data communication antenna, wherein the data communication module is configured to transmit and/or receive data wirelessly.

14. The powered module according to claim 13, wherein the data can be transmitted and/or received using a long-range, low-power communication protocol or a long-range RF data transmission protocol.

15. The powered module according to claim 13, wherein the powered module is part of a system, where the system further comprises at least one wireless data communication gateway, the at least one wireless data communication gateway is configured to broadcast downlink data to the data communication module, the data communication module is configured to uplink data to the at least one wireless data communication gateway.

16. The powered module according to claim 15, wherein the at least one wireless data communication gateway is mobile.

17. The powered module according to claim 1, wherein the flexible printed circuit assembly further includes a global positioning system (GPS) antenna and a GPS integrated circuit, wherein the GPS antenna is configured to collect a signal from GPS satellites, and wherein the GPS integrated circuit is configured to collect relevant GPS location and time data from a constellation of GPS satellites through the GPS antenna. GPS or any location data can be transmitted wirelessly according to claim 13.

18. The powered module according to claim 1, wherein the programmed media message can be reprogrammed.

19. A method of dissemination of a media message in mass by means of an airdrop to an identifiable target area, the method comprising the steps of:
identifying the target area;
providing a plurality of modules containing a circuit assembly, the circuit assembly configured to store a media message therein and to play the media message stored therein upon activation of the circuit assembly;
distributing in mass the plurality of modules to the target area by means of the airdrop; and
after distribution, broadcasting a first media message to one or more of the plurality of modules to be stored by the circuit assembly such that the first media message can thereafter be played upon activation of the circuit assembly.

20. The method according to claim 19, wherein the broadcasting of the first media message occurs after the airdrop has occurred, but before the plurality of modules have landed in the target area.

21. The method according to claim 19, wherein the broadcasting of the first media message occurs after the airdrop has occurred, and after the plurality of modules have landed in the target area.

22. The method according to claim 19, further comprising the step of broadcasting a second media message to a predetermined set of the plurality of modules when it is determined that the predetermined set of the plurality of modules did not land in the target area, wherein the second media message is different than the first media message.

23. The method according to claim 19, further comprising the step of broadcasting a second media message to a predetermined set of the plurality of modules when it is determined that the predetermined set of the plurality of modules has been moved from the target area to a non-target area, wherein the second media message is different than the first media message.

24. The method according to claim 19, further comprising the step of broadcasting a second media message to a predetermined set of the plurality of modules, wherein the second media message is different than the first media message, and wherein the broadcasting of the second media message occurs after the first media message has been played.

25. The method according to claim 19, further comprising the step of broadcasting a second media message to a predetermined set of the plurality of modules, wherein the second media message is different than the first media message, and wherein the broadcasting of the second media message occurs prior to the first media message having been played.

26. The method according to claim 19, further comprising the step of broadcasting a second media message to a predetermined set of the plurality of modules, wherein the second media message is different than the first media message, and wherein the broadcasting of the second media message causes the first media message to be erased from the circuit assembly.

27. The method according to claim 19, wherein the activation of each circuit assembly occurs, such that the first media message is played, by an unfolding of the module containing the respective circuit assembly.

28. The method according to claim 19, wherein the activation of each circuit assembly occurs, such that the media message is played, by an initiation device of the circuit assembly being activated.

29. The method according to claim 26, wherein the initiation device of the circuit assembly comprises one or more of a button, a switch, and a sensor.

30. The method according to claim 19, wherein each module comprises a leaflet.

31. The method according to claim 19, wherein the circuit assembly is a flexible printed circuit assembly.
